(19) United States
(12) Patent Application Publication
(10) Pub. No.: US 2009/0262046 A1
(43) Pub. Date: Oct. 22, 2009

(54) HIGH APERTURE RATIO PIXEL LAYOUT FOR DISPLAY DEVICE

(75) Inventors: Arokia Nathan, Cambridge (GB); G. Reza Chaji, Waterloo (CA)

Correspondence Address: SHUMAKER & SIEFFERT, P. A., 1625 RADIO DRIVE, SUITE 300, WOODBURY, MN, 55125, US

(73) Assignee: Ignis Innovation, Inc., Kitachener (CA)

(21) Appl. No.: 12/259,733

(22) Filed: Oct. 28, 2008

(30) Foreign Application Priority Data
Oct. 29, 2007 (CA) 2,610,148

(51) Int. Cl. G09G 3/30

(52) U.S. Cl. 345/76

(57) ABSTRACT

A display device, pixel layout and method of forming the same is provided. The display device includes: a plurality of pixels formed in a pixel array area; and a power supply grid for distributing power to the pixels. Each pixel has a light emitting device and a plurality of transistors. The power supply grid includes a first group of power supply lines and a second group of power supply lines. The first group of power supply lines extend across the pixel array area. The second group of power supply lines extends across the pixel array area and electrically contacts the first group of power supply lines in the pixel array area. Each pixel is coupled to at least one power supply line in the first group of power supply lines and the second group of power supply lines.

### FIELD OF INVENTION

The present invention relates to a display device, and more specifically to a display device having a plurality of pixels with high aperture ratio.

### BACKGROUND OF THE INVENTION

Active-matrix organic light-emitting diode (AMOLED) displays have become more attractive due to their advantages, such as, low temperature fabrication, its low cost fabrication, and a high resolution with a wide viewing angle.

FIG. 1 illustrates a power supply line distribution in a conventional AMOLED display panel. The panel display device 10 of FIG. 1 includes a plurality of pixels arranged in rows and columns. In the panel, each column (or row) has its own power supply line 12 or shares it with its adjacent column (or row). The power supply lines 12 are extended vertically and connected to panel power supply bars 14 disposed horizontally in two sides of the panel. The panel power supply bars 14 provide driving voltages to the power supply lines 12. Each pixel operates using power provided through the corresponding power supply line 12.

FIG. 2 illustrates an example of a RGBW pixel layout of FIG. 1. A region 25 contains a pixel 20 having four pixel components 22a (White), 22b (Red), 22c (Blue), and 22d (Green). Each pixel component operates using power provided through the corresponding power supply line 12.

In FIG. 2, the column of the pixel 20 shares two power supply lines 12 with its adjacent columns. Thus it is not required to dispose a power supply line for each column. However, in a large-area display with high current density, the power supply line 12 should be wide. As a result, the aperture ratio is compromised reducing the panel lifetime.

### SUMMARY OF THE INVENTION

It is an object of the invention to provide a display device that obviates or mitigates at least one of the disadvantages of existing systems.

According to an aspect of the present invention there is provided a display device includes: a plurality of pixels formed in a pixel array area; and a power supply grid for distributing power to the pixels. Each pixel has a light emitting device and a plurality of transistors. The power supply grid includes a first group of power supply lines and a second group of power supply lines. The first group of power supply lines extends across the pixel array area. The second group of power supply lines extends across the pixel array area and electrically contacts the first group of power supply lines in the pixel array area. Each pixel is coupled to at least one power supply line in the first group of power supply lines and the second group of power supply lines.

### BRIEF DESCRIPTION OF THE DRAWINGS

These and other features of the invention will become more apparent from the following description in which reference is made to the appended drawings wherein:

FIG. 1 is a schematic diagram illustrating a conventional power supply line distribution layout for an AMOLED display panel;

FIG. 2 is a schematic diagram illustrating a RGBW pixel layout for the panel of FIG. 1;

FIG. 3 is a schematic diagram illustrating an example of a power supply grid layout for a display panel, in accordance with an embodiment of the present invention;

FIG. 4 is a schematic diagram illustrating an example of a RGBW pixel layout for the panel of FIG. 3.

FIG. 5 is a schematic diagram illustrating an example of a pixel circuit for the pixel layout of FIG. 4;

FIG. 6 is a plan view illustrating a RGBW pixel layout with the power supply grid and the pixel circuit of FIG. 5;

FIG. 7 is a vertical cross section view of the RGBW pixel of FIG. 6; and

FIG. 8 is a horizontal cross section view of the RGBW pixel of FIG. 6.

### DETAILED DESCRIPTION

Embodiments of the present invention are described using a panel having a pixel with an OLED, e.g., AMOLED display panels, OLED flat panels. However, any display device driven by a power supply line for supplying power to a light emitting device (or layer) falls within the scope of the embodiments.

In the embodiments, relative terms, such as “horizontal” and “vertical” are used to describe the geographical relationship among elements. However, it will be appreciated by one of ordinary skill in the art that the terms “horizontal” and “vertical” are examples only, and may encompass two different directions which are determined, for example, by the requirement of a pixel layout.

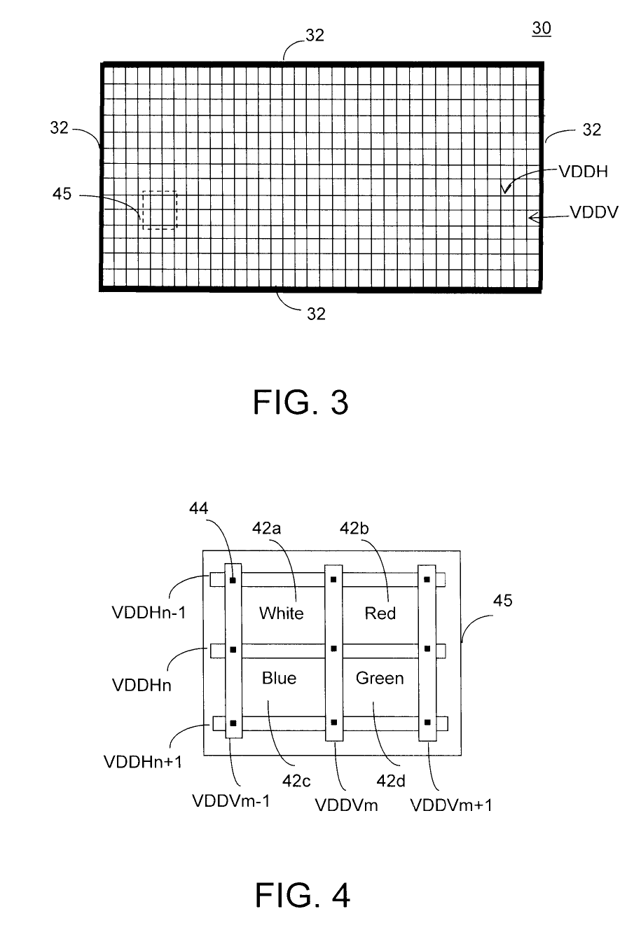

Referring to FIG. 3, a power supply grid layout for a panel in accordance with an embodiment of the present invention is described. The panel display device 30 of FIG. 3 contains a power supply grid that can reduce the width of each power supply line, thereby reducing the IR-drop and increasing the aperture ratio.

The power supply grid includes a plurality of power supply lines VDDVs extended in a first direction (e.g., vertically) across a pixel array area and a plurality of power supply lines VDDHs extended in a second direction (e.g., horizontally) across the pixel array area. The power supply lines VDDV and VDDH are electrically connected at their cross points in the pixel array area. The power supply lines VDDVs and VDDHs may be formed by different metals, ITO, or any other conductor used in the panel.

In FIG. 3, the panel has a rectangular shape. However, the panel may have a shape different from that of FIG. 3, as would be appreciated by one of ordinary skill in the art. In FIG. 3, “VDDH” extends in a direction perpendicular to “VDDV”. However, Each of “VDDH” and “VDDV” may extend in a direction different from that shown in FIG. 3. It would be appreciated by one of ordinary skill in the art that the number of VDDVs and VDDHs may vary based on the pixel layout and current densities.

The power supply lines VDDVs and VDDHs are connected to a panel VDD ring 32 disposed in the periphery of the panel. In FIG. 3, the VDD ring 32 is formed so as to surround the rectangle-shaped panel. The VDD ring 32 has main wires that provide a driving voltage to each power supply line VDDV, VDDH.

The panel may be a bottom emission type display or a top emission type display, including bottom and top emission displays for RGB and RGBW. The panel includes a plurality of pixels arranged in row and column. The VDD power is distributed to the pixels in the panel uniformly, through the power supply lines VDDVs and VDDHs.

The power supply grid provides a better (lower) resistance and distribution. There is no need to use wide metals for VDDH and VDDV. The width of each power supply line VDDH, VDDV can be small while the effective resistance is low.

The power supply lines VDDVs and VDDHs distribute VDD voltage and current across the panel uniformly, which results in minimizing IR drop across the panel (especially when the panel of FIG. 3 is a large panel with high luminance).

FIG. 4 illustrates an example of a RGBW pixel layout for the panel of FIG. 3. In FIG. 4, “VDDHi” (i=n−1, n, n+1) represents a power supply line corresponding to VDDH of FIG. 3; “VDDVj” (j=m−1, m, m+1) represents a power supply line corresponding to VDDV of FIG. 3. In FIG. 4, a pixel region 45 contains a pixel 40 having four pixel components (circuits) 42a, 42b, 42c, and 42d for “White”, “Red”, “Blue”, and “Green”, respectively. The power supply line VDDVj and the power supply line VDDHi are electrically connected at a contact point 44. For example, VDDHn−1 is connected to VDDVm−1, VDDVm, and VDDVm+1, where each of VDDVm−1, VDDVm and VDDVm+1 is further connected to VDDHn and VDDHn+1.

Each of the “White”, “Red”, “Blue”, and “Green” pixel components 42a-42d is connected to a plurality of power supply lines and uses VDD voltage/current from them. For example, VDDHn−1 is directly connected to a transistor for the White pixel component 42a where VDDHn−1 is connected to VDDVm−1 and VDDVm. VDDHn may be directly coupled to the White pixel component 42a, the Red pixel component 42c, the Blue pixel component 42c, and the Green pixel component 42d. VDDHi may be shared with another pixel (not shown in FIG. 4). Similarly VDDVj may be shared with another pixel (not shown in FIG. 4).

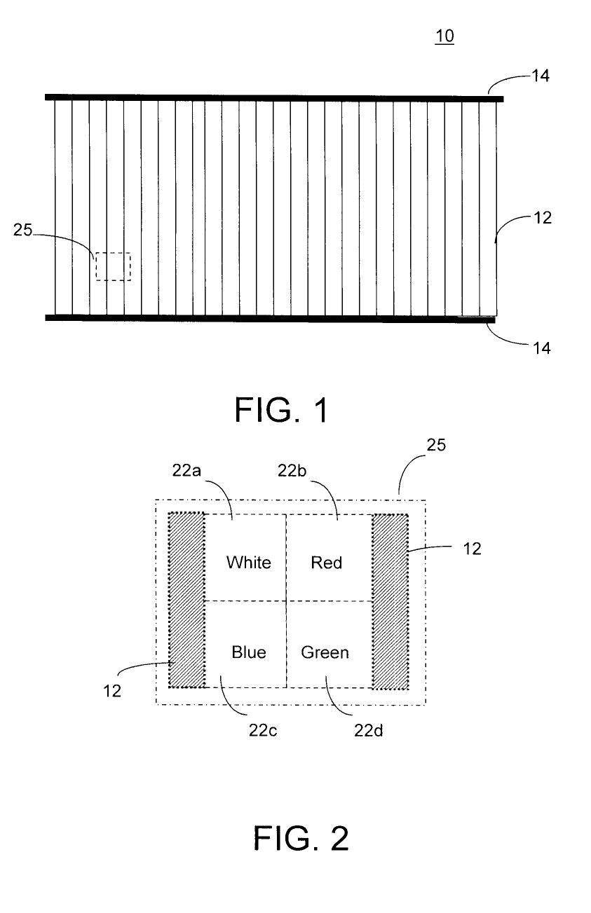

The power supply lines VDDHi and VDDVj distribute VDD power to the pixels uniformly. The width of each power supply lines VDDHi and VDDVj can be smaller than that of FIG. 1, and the effective resistance of each power supply line VDDHi, VDDVj is low.

In this example, each pixel component is defined by two power supply lines VDDVs extending in a first direction and two power supply lines VDDHs extending in a second direction perpendicular to the first direction. However, the number of VDDVs and VDDHs varies based on the pixel layout and current densities.

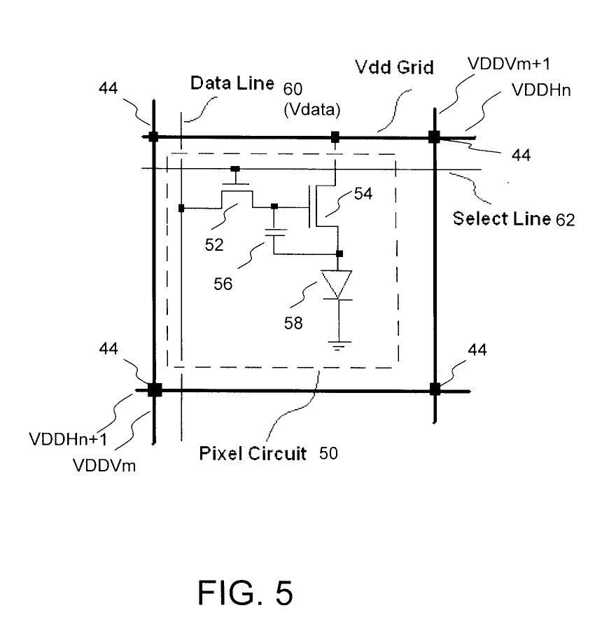

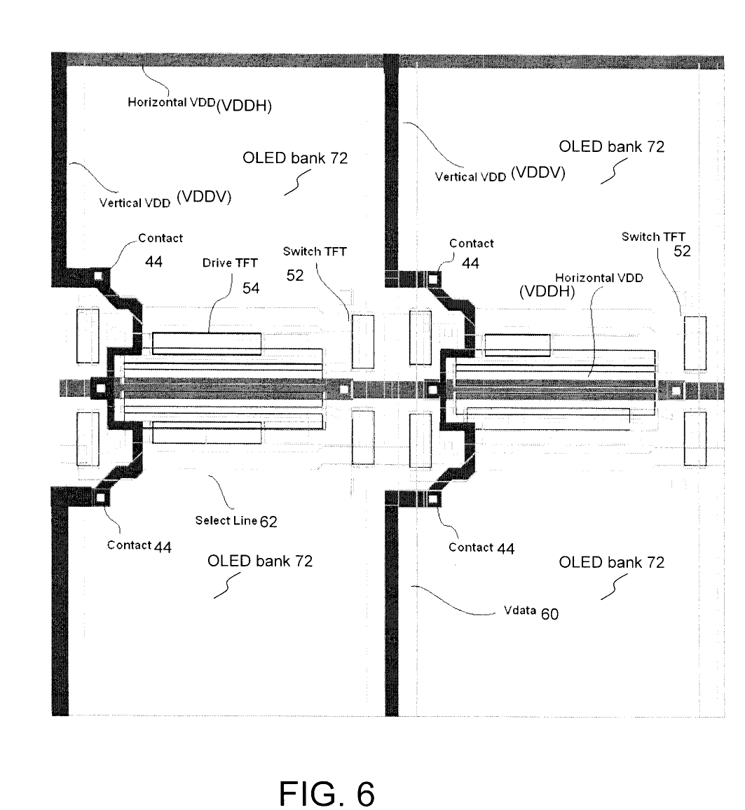

FIG. 5 illustrates an example of a pixel circuit for the RGBW pixel layout of the FIG. 4. The pixel circuit 50 of FIG. 5 includes a switch transistor 52, a drive transistor 54, a storage capacitor 56, and an OLED 58. The pixel circuit 50 corresponds to, for example, the pixel component 42d (“Green”) of FIG. 4.

The transistors 52 and 54 are thin film transistors (TFTTs). Each transistor has a gate terminal and first and second terminals (e.g., source/drain). The gate terminal of the switch transistor 52 is connected to a select line (address line) 62. The first and second terminals of the switch transistor 52 is connected between a data line (Vdata) 60 and the gate terminal of the drive transistor 54. The first and second terminals of the drive transistor 54 is connected to the power supply line VDDHn and the OLED 58. The storage capacitor 56 is connected to the gate terminal of the drive transistor 54 and the OLED 58. The power supply line VDDHn is connected to the power supply lines VDDVm and VDDVm+1 that are connected to the power supply line VDDVn+1.

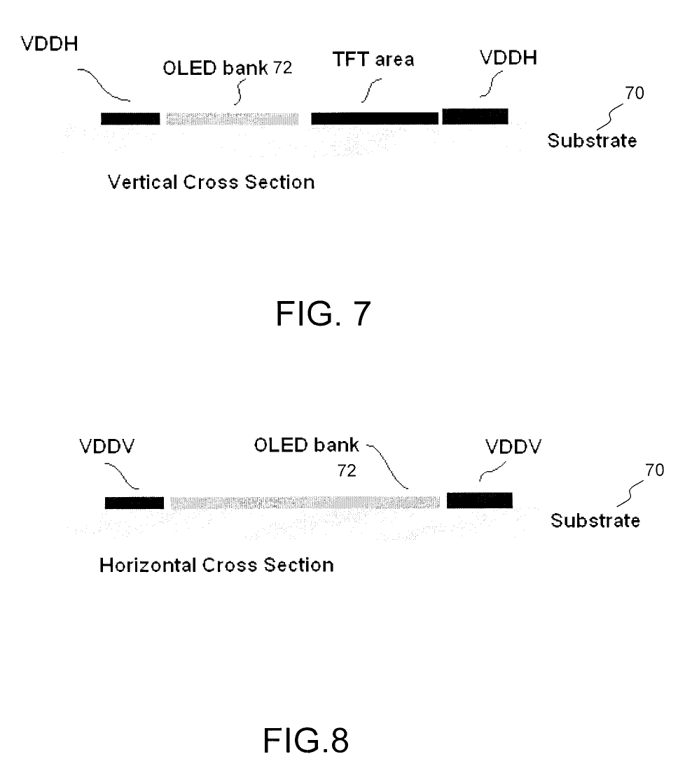

FIG. 6 illustrates a plan view of a RGBW pixel layout with the power supply grid and the pixel circuit of FIG. 5. FIG. 7 illustrates a vertical cross section view of the RGBW pixel of FIG. 6. FIG. 8 illustrates a horizontal cross section view of the RGBW pixel of FIG. 6.

Referring to FIGS. 5-8, the power supply lines VDDH and VDDV are fitted between the distances between OLED banks 72 so that the aperture ratio is not affected. The panel using the pixel of FIG. 6 provides for front screen luminance of, for example, 500 cd/m2 after polarizer imposing large current density at peak luminance. In the panel of FIG. 6, large TFTs are used to reduce the aging of the TFT. However, the aperture ratio is higher than 58%. Moreover, the resistance of between the VDD contact (44 of FIG. 4) and each pixel is negligible since each contact carry only small current for each pixel while the power supply lines VDDHs and VDDVs carry the entire current for the panel.

One or more currently preferred embodiments have been described by way of example. It will be apparent to persons skilled in the art that a number of variations and modifications can be made without departing from the scope of the invention as defined in the claims.

What is claimed is:

1. A display device comprising:
a plurality of pixels formed in a pixel array area, each having a light emitting device and a plurality of transistors; and
a power supply grid for distributing power to the pixels, the power supply grid including a first group of power supply lines and a second group of power supply lines, the first group of power supply lines extending across the pixel array area, the second group of power supply lines extending across the pixel array area and electrically contacting the first group of power supply lines in the pixel array area, each pixel being coupled to at least one power supply line in the first group of power supply lines and the second group of power supply lines.

2. A display device as claimed in claim 1, wherein the power supply grid distributes uniform current to the pixels.

3. A display device as claimed in claim 1, wherein the power supply grid distributes uniform voltage to the pixels.

4. A display device as claimed in claim 1, wherein the power supply grid comprises:
a coupler coupled to the first group of power supply lines and the second group of power supply lines.

5. A display device as claimed in claim 4, wherein the coupler comprises:
a power supply ring structure disposed on the periphery of the pixel array, coupled to the first group of power supply lines and the second group of power supply lines.

6. A display device as claimed in claim 1, wherein the light emitting device is an organic light emitting diode (OLED).

7. A display device as claimed in claim 6, wherein the first group of power supply lines are formed between OLED banks.

8. A display device as claimed in claim 7, wherein the second group of power supply lines are formed between OLED banks.

9. A display device as claimed in claim 1, wherein a power supply line in the first group of power lines is directly coupled to adjacent pixels.

10. A display device as claimed in claim 1, wherein a power supply line in the first group of power lines is formed between two adjacent pixels

11. A display device as claimed in claim 1, wherein the pixel array has a RGB top emission or bottom emission structure.

12. A display device as claimed in claim 1, wherein the pixel array has a RGBW top emission or bottom emission structure.
